(19) United States
(12) Patent Application Publication
(10) Pub. No.: US 2023/0132052 A1
(43) Pub. Date: Apr. 27, 2023

(54) COOPERATIVE OPERATION FOR SIDELINK BANDWIDTH PART

(71) Applicant: QUALCOMM Incorporated, San Diego, CA (US)

(72) Inventors: Qing LI, Princeton Junction, NJ (US); Junyi LI, Fairless Hills, PA (US); Hong CHENG, Basking Ridge, NJ (US)

(21) Appl. No.: 17/451,781

(22) Filed: Oct. 21, 2021

(51) Int. Cl. H04W 72/12; H04L 5/00; H04W 72/00

(52) U.S. Cl. CPC H04W 72/1278; H04L 5/0092; H04L 5/0096; H04W 72/005

(57) ABSTRACT

Various aspects of the present disclosure generally relate to wireless communication. In some aspects, a first user equipment (UE) may identify a first sidelink (SL) bandwidth part (BWP) of the first UE and a second SL BWP of a second UE. In some aspects, the first UE may adjust the first SL BWP based at least in part on a partial overlap between the first SL BWP and the second SL BWP. In some aspects, the first UE may transmit, to the second UE based at least in part on the partial overlap between the first SL BWP and the second SL BWP, an indication associated with adjusting the second SL BWP. Numerous other aspects are described.

### FIELD OF THE DISCLOSURE

Aspects of the present disclosure generally relate to wireless communication and to techniques and apparatuses for cooperative operation for a sidelink bandwidth part (BWP).

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication performed by a first user equipment (UE) includes identifying a first sidelink (SL) bandwidth part (BWP) of the first UE and a second SL BWP of a second UE; and one of: making an adjustment associated with the first SL BWP based at least in part on a partial overlap between the first SL BWP and the second SL BWP; or transmitting, to the second UE based at least in part on the partial overlap between the first SL BWP and the second SL BWP, an indication associated with adjusting the second SL BWP.

In some aspects, a method of wireless communication performed by a network node includes identifying a first SL BWP of a first UE and a second SL BWP of a second UE; and transmitting, to the first UE based at least in part on a partial overlap between the first SL BWP and the second SL BWP, an indication associated with adjusting the first SL BWP.

In some aspects, a first UE for wireless communication includes a memory; and one or more processors, coupled to the memory, configured to: identify a first SL BWP of the first UE and a second SL BWP of a second UE; and one of: make an adjustment associated with the first SL BWP based at least in part on a partial overlap between the first SL BWP and the second SL BWP; or transmit, to the second UE based at least in part on the partial overlap between the first SL BWP and the second SL BWP, an indication associated with adjusting the second SL BWP.

In some aspects, a network node for wireless communication includes a memory; and one or more processors, coupled to the memory, configured to: identify a first SL BWP of a first UE and a second SL BWP of a second UE; and transmit, to the first UE based at least in part on a partial overlap between the first SL BWP and the second SL BWP, an indication associated with adjusting the first SL BWP.

In some aspects, a non-transitory computer-readable medium storing a set of instructions for wireless communication includes one or more instructions that, when executed by one or more processors of a first UE, cause the UE to: identify a first SL BWP of the first UE and a second SL BWP of a second UE; and one of: make an adjustment associated with the first SL BWP based at least in part on a partial overlap between the first SL BWP and the second SL BWP; or transmit, to the second UE based at least in part on the partial overlap between the first SL BWP and the second SL BWP, an indication associated with adjusting the second SL BWP.

In some aspects, a non-transitory computer-readable medium storing a set of instructions for wireless communication includes one or more instructions that, when executed by one or more processors of a network node, cause the network node to: identify a first SL BWP of a first UE and a second SL BWP of a second UE; and transmit, to the first UE based at least in part on a partial overlap between the first SL BWP and the second SL BWP, an indication associated with adjusting the first SL BWP.

In some aspects, an apparatus for wireless communication includes means for identifying a first SL BWP of the apparatus and a second SL BWP of a UE; and one of: means for making an adjustment associated with the first SL BWP based at least in part on a partial overlap between the first SL BWP and the second SL BWP; or means for transmitting, to the UE based at least in part on the partial overlap between the first SL BWP and the second SL BWP, an indication associated with adjusting the second SL BWP.

In some aspects, an apparatus for wireless communication includes means for identifying a first SL BWP of a first UE and a second SL BWP of a second UE; and means for transmitting, to the first UE based at least in part on a partial overlap between the first SL BWP and the second SL BWP, an indication associated with adjusting the first SL BWP.

Aspects generally include a method, apparatus, system, computer program product, non-transitory computer-readable medium, user equipment, base station, wireless communication device, and/or processing system as substantially described herein with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of sidelink communications, in accordance with the present disclosure.

FIG. 4 is a diagram illustrating an example of sidelink communications and access link communications, in accordance with the present disclosure.

FIG. 5 is a diagram illustrating an example of overlapped sidelink (SL) bandwidth parts (BWPs), in accordance with the present disclosure.

FIG. 6 is a flow diagram illustrating an example of adjusting an SL BWP based at least in part on a partial overlap, in accordance with the present disclosure.

FIG. 7 is a diagram illustrating an example of signaling associated with adjustment of an SL BWP to eliminate a partial overlap, in accordance with the present disclosure.

FIG. 8 is a diagram illustrating an example of signaling associated with adjustment of an SL BWP to align partially overlapped SL BWPs, in accordance with the present disclosure.

FIG. 9 is a diagram illustrating an example of signaling associated with adjustment of an SL BWP by a special UE, in accordance with the present disclosure.

FIG. 10 is a diagram illustrating an example process performed, for example, by a UE, in accordance with the present disclosure.

FIG. 11 is a diagram illustrating an example process performed, for example, by a network node, in accordance with the present disclosure.

FIG. 12 is a diagram of an example apparatus for wireless communication, in accordance with the present disclosure.

FIG. 13 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

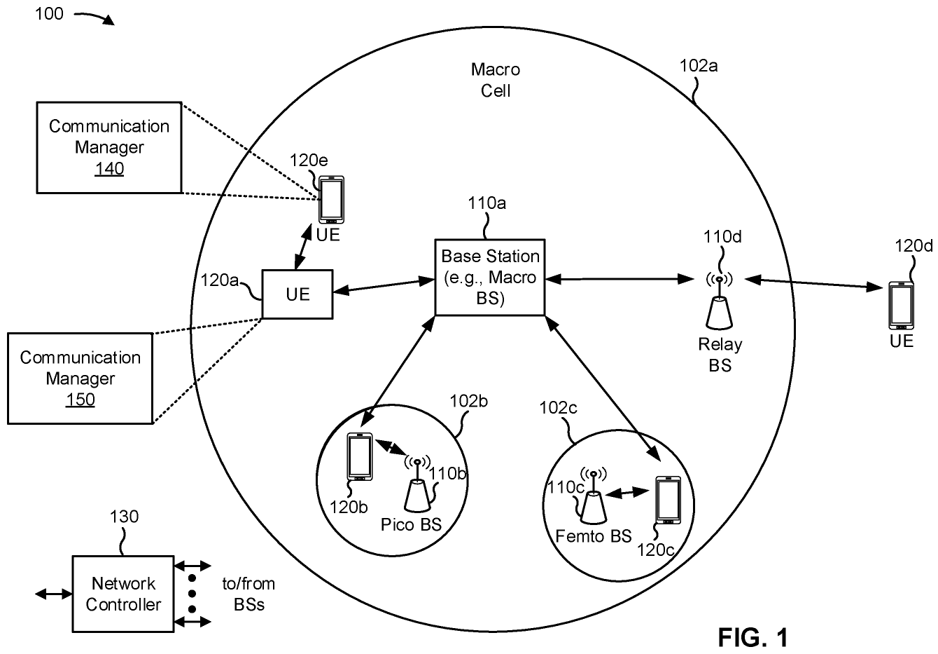

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may identify a first sidelink (SL) bandwidth part (BWP) of the first UE and a second SL BWP of a second UE; adjust the first SL BWP based at least in part on a partial overlap between the first SL BWP and the second SL BWP; or transmit, to the second UE based at least in part on the partial overlap between the first SL BWP and the second SL BWP, an indication associated with adjusting the second SL BWP. Additionally, or alternatively, the communication manager 140 may perform one or more other operations described herein.

In some aspects, a network node (such as the UE 120 or the base station 110) may include a communication manager 150. As described in more detail elsewhere herein, the communication manager 150 may identify a first SL BWP of a first UE and a second SL BWP of a second UE; and transmit, to the first UE based at least in part on a partial overlap between the first SL BWP and the second SL BWP, an indication associated with adjusting the first SL BWP. Additionally, or alternatively, the communication manager 150 may perform one or more other operations described herein.

As indicated above, FIG. 1 is provided as an example. Other examples may differ from what is described with regard to FIG. 1.

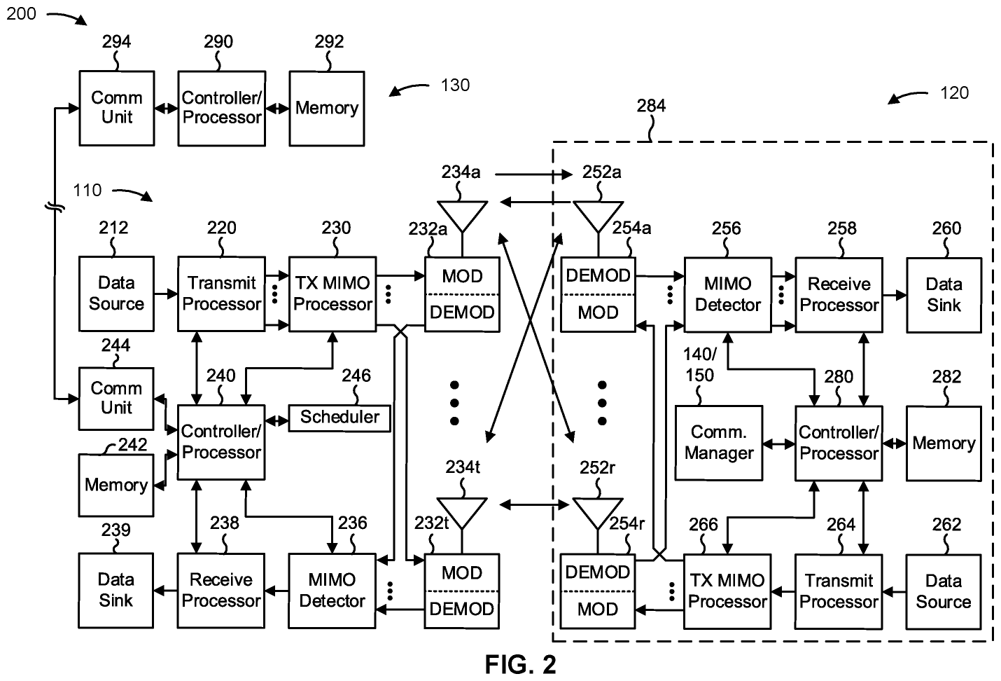

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

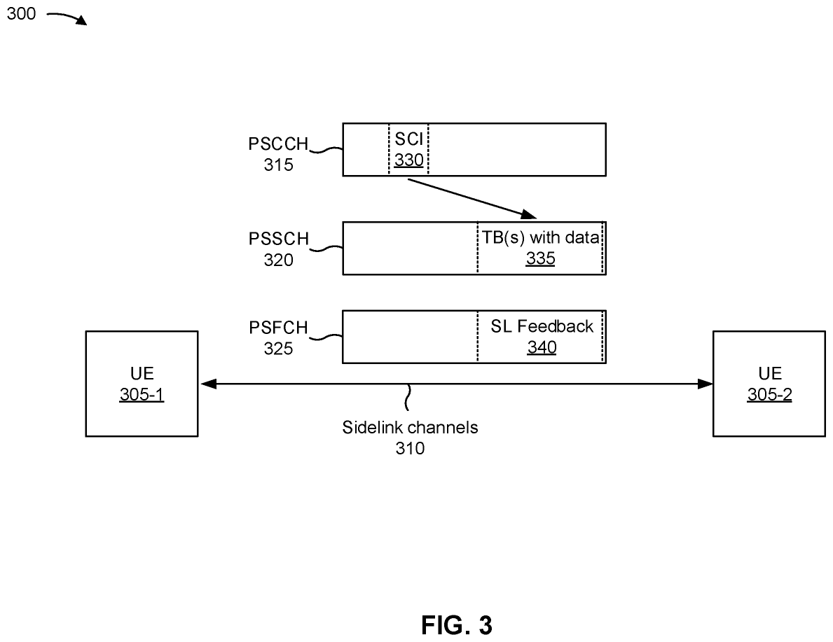

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 3-13).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 3-13).

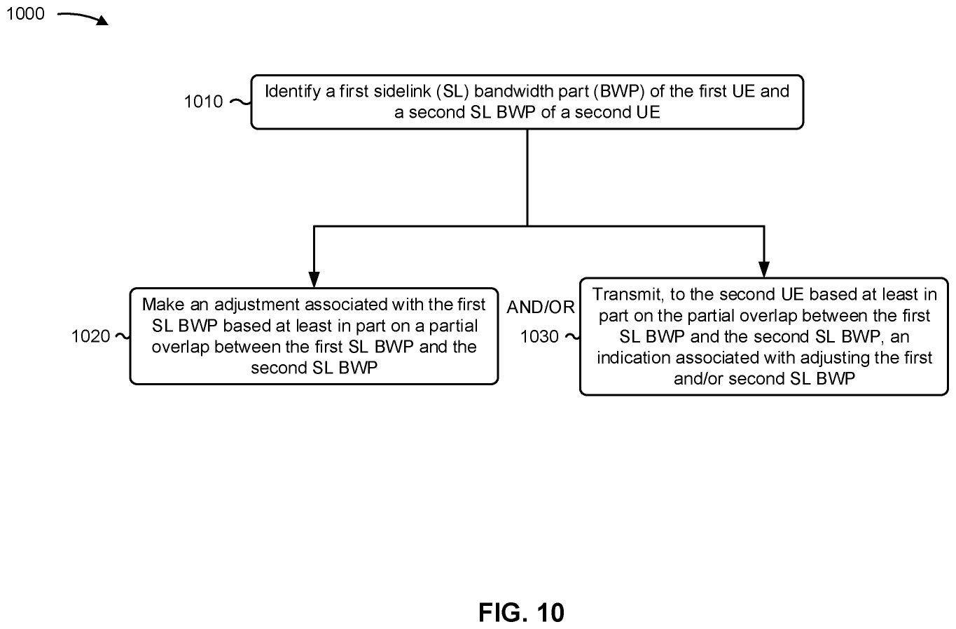

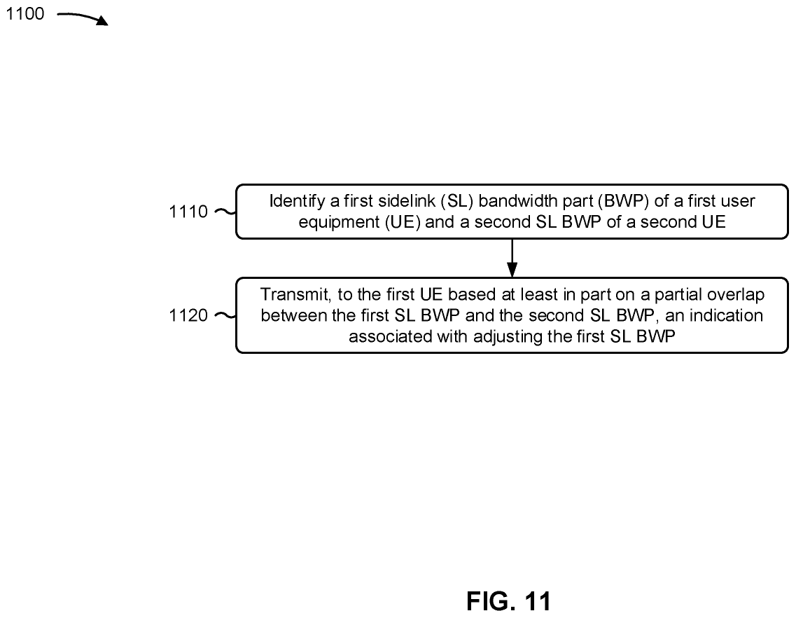

The controller/processor 240 of the base station 110, the controller/processor 280 of the UE 120, and/or any other component(s) of FIG. 2 may perform one or more techniques associated with cooperative operation for sidelink BWPs, as described in more detail elsewhere herein. For example, the controller/processor 240 of the base station 110, the controller/processor 280 of the UE 120, and/or any other component(s) of FIG. 2 may perform or direct operations of, for example, process 1000 of FIG. 10, process 1100 of FIG. 11, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 1000 of FIG. 10, process 1100 of FIG. 11, and/or other processes as described herein. In some examples, executing instructions may include running the instructions, converting the instructions, compiling the instructions, and/or interpreting the instructions, among other examples.

In some aspects, a UE 120 includes means for identifying a first SL BWP of the UE 120 and a second SL BWP of a second UE; means for making an adjustment associated with the first SL BWP based at least in part on a partial overlap between the first SL BWP and the second SL BWP; or means for transmitting, to the second UE based at least in part on the partial overlap between the first SL BWP and the second SL BWP, an indication associated with adjusting the second SL BWP. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., UE 120) includes means for identifying a first SL BWP of a first UE and a second SL BWP of a second UE; and/or means for transmitting, to the first UE based at least in part on a partial overlap between the first SL BWP and the second SL BWP, an indication associated with adjusting the first SL BWP. In some aspects, the means for the network node to perform operations described herein may include, for example, one or more of communication manager 150, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

FIG. 3 is a diagram illustrating an example 300 of sidelink communications, in accordance with the present disclosure.

As shown in FIG. 3, a first UE 305-1 may communicate with a second UE 305-2 (and one or more other UEs 305) via one or more sidelink channels 310. The UEs 305-1 and 305-2 may communicate using the one or more sidelink channels 310 for P2P communications, D2D communications, V2X communications (e.g., which may include V2V communications, V2I communications, and/or V2P communications) and/or mesh networking. In some aspects, the UEs 305 (e.g., UE 305-1 and/or UE 305-2) may correspond to one or more other UEs described elsewhere herein, such as UE 120. In some aspects, the one or more sidelink channels 310 may use a PC5 interface and/or may operate in a high frequency band (e.g., the 5.9 GHz band). Additionally, or alternatively, the UEs 305 may synchronize timing of transmission time intervals (TTIs) (e.g., frames, subframes, slots, or symbols) using global navigation satellite system (GNSS) timing.

As further shown in FIG. 3, the one or more sidelink channels 310 may include a physical sidelink control channel (PSCCH) 315, a physical sidelink shared channel (PSSCH) 320, and/or a physical sidelink feedback channel (PSFCH) 325. The PSCCH 315 may be used to communicate control information, similar to a physical downlink control channel (PDCCH) and/or a physical uplink control channel (PUCCH) used for cellular communications with a base station 110 via an access link or an access channel. The PSSCH 320 may be used to communicate data, similar to a physical downlink shared channel (PDSCH) and/or a physical uplink shared channel (PUSCH) used for cellular communications with a base station 110 via an access link or an access channel. For example, the PSCCH 315 may carry sidelink control information (SCI) 330, which may indicate various control information used for sidelink communications, such as one or more resources (e.g., time resources, frequency resources, and/or spatial resources) where a transport block (TB) 335 may be carried on the PSSCH 320. The TB 335 may include data. The PSFCH 325 may be used to communicate sidelink feedback 340, such as hybrid automatic repeat request (HARQ) feedback (e.g., acknowledgement or negative acknowledgement (ACK/NACK) information), transmit power control (TPC), and/or a scheduling request (SR).

Although shown on the PSCCH 315, in some aspects, the SCI 330 may include multiple communications in different stages, such as a first stage SCI (SCI-1) and a second stage SCI (SCI-2). The SCI-1 may be transmitted on the PSCCH 315. The SCI-2 may be transmitted on the PSSCH 320. The SCI-1 may include, for example, an indication of one or more resources (e.g., time resources, frequency resources, and/or spatial resources) on the PSSCH 320, information for decoding sidelink communications on the PSSCH, a quality of service (QoS) priority value, a resource reservation period, a PSSCH DMRS pattern, an SCI format for the SCI-2, a beta offset for the SCI-2, a quantity of PSSCH DMRS ports, and/or an MCS. The SCI-2 may include information associated with data transmissions on the PSSCH 320, such as a HARQ process ID, a new data indicator (NDI), a source identifier, a destination identifier, and/or a channel state information (CSI) report trigger.

In some aspects, the one or more sidelink channels 310 may use resource pools. For example, a scheduling assignment (e.g., included in SCI 330) may be transmitted in sub-channels using specific resource blocks (RBs) across time. In some aspects, data transmissions (e.g., on the PSSCH 320) associated with a scheduling assignment may occupy adjacent RBs in the same subframe as the scheduling assignment (e.g., using frequency division multiplexing). Resource pools may be configured for a UE, such as by another UE or a base station. In some aspects, a scheduling assignment and associated data transmissions are not transmitted on adjacent RBs.

In some aspects, a UE 305 may operate using a sidelink transmission mode (e.g., Mode 1) where resource selection and/or scheduling is performed by a base station 110. For example, the UE 305 may receive a grant (e.g., in downlink control information (DCI) or in a radio resource control (RRC) message, such as for configured grants) from the base station 110 for sidelink channel access and/or scheduling. In some aspects, a UE 305 may operate using a transmission mode (e.g., Mode 2) where resource selection and/or scheduling is performed by the UE 305 (e.g., rather than a base station 110). In some aspects, the UE 305 may perform resource selection and/or scheduling by sensing channel availability for transmissions. For example, the UE 305 may measure an RSSI parameter (e.g., a sidelink-RSSI (S-RSSI) parameter) associated with various sidelink channels, may measure an RSRP parameter (e.g., a PSSCH-RSRP parameter) associated with various sidelink channels, and/or may measure an RSRQ parameter (e.g., a PSSCH-RSRQ parameter) associated with various sidelink channels, and may select a channel for transmission of a sidelink communication based at least in part on the measurement(s).

Additionally, or alternatively, the UE 305 may perform resource selection and/or scheduling using SCI 330 received in the PSCCH 315, which may indicate occupied resources and/or channel parameters. Additionally, or alternatively, the UE 305 may perform resource selection and/or scheduling by determining a channel busy rate (CBR) associated with various sidelink channels, which may be used for rate control (e.g., by indicating a maximum number of resource blocks that the UE 305 can use for a particular set of subframes).

In the transmission mode where resource selection and/or scheduling is performed by a UE 305, the UE 305 may generate sidelink grants, and may transmit the grants in SCI 330. A sidelink grant may indicate, for example, one or more parameters (e.g., transmission parameters) to be used for an upcoming sidelink transmission, such as one or more resource blocks to be used for the upcoming sidelink transmission on the PSSCH 320 (e.g., for TBs 335), one or more subframes to be used for the upcoming sidelink transmission, and/or an MCS to be used for the upcoming sidelink transmission. In some aspects, a UE 305 may generate a sidelink grant that indicates one or more parameters for semi-persistent scheduling (SPS), such as a periodicity of a sidelink transmission. Additionally, or alternatively, the UE 305 may generate a sidelink grant for event-driven scheduling, such as for an on-demand sidelink message.

UEs 305 may communicate on a sidelink BWP. For example, different UEs may be associated with different sidelink BWPs (e.g., corresponding to different services). As another example, different UEs 305 may use aligned sidelink BWPs for communication, such as in connection with a broadcast, multicast, or groupcast communication. The techniques and apparatuses described herein provide cooperation between UEs 305, such as for the purpose of eliminating undesired overlap between sidelink BWPs, or for the purpose of aligning misaligned sidelink BWPs for the purpose of broadcast, multicast, or groupcast communication.

As indicated above, FIG. 3 is provided as an example. Other examples may differ from what is described with respect to FIG. 3.

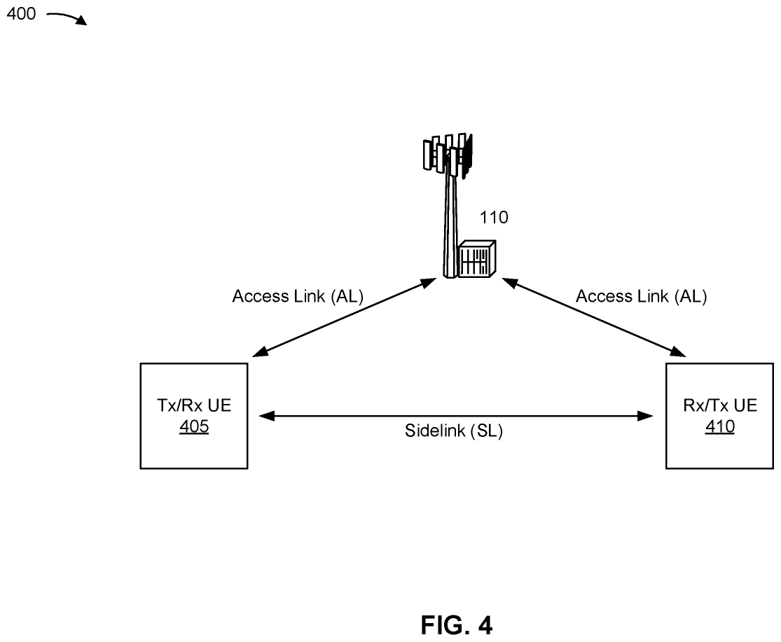

FIG. 4 is a diagram illustrating an example 400 of sidelink communications and access link communications, in accordance with the present disclosure.

As shown in FIG. 4, a transmitter (Tx)/receiver (Rx) UE 405 and an Rx/Tx UE 410 may communicate with one another via a sidelink, as described above in connection with FIG. 3. As further shown, in some sidelink modes, a base station 110 may communicate with the Tx/Rx UE 405 via a first access link. Additionally, or alternatively, in some sidelink modes, the base station 110 may communicate with the Rx/Tx UE 410 via a second access link. The Tx/Rx UE 405 and/or the Rx/Tx UE 410 may correspond to one or more UEs described elsewhere herein, such as the UE 120 of FIG. 1. Thus, a direct link between UEs 120 (e.g., via a PC5 interface) may be referred to as a sidelink, and a direct link between a base station 110 and a UE 120 (e.g., via a Uu interface) may be referred to as an access link. Sidelink communications may be transmitted via the sidelink, such as via one or more sidelink BWPs, and access link communications may be transmitted via the access link. An access link communication may be either a downlink communication (from a base station 110 to a UE 120) or an uplink communication (from a UE 120 to a base station 110). In some aspects, the UEs 405 and 410 may be associated with another UE that performs configuration and/or management of resources for the UE 405 and 410, such as configuration of sidelink BWPs, resource pools, or the like. The other UE may be referred to herein as a special UE or a network node. In some aspects, the other UE may include a roadside unit (RSU), a group lead, a cluster head, a scheduler UE, or the like. In some aspects, “network node” may refer to a special UE.

As indicated above, FIG. 4 is provided as an example. Other examples may differ from what is described with respect to FIG. 4.

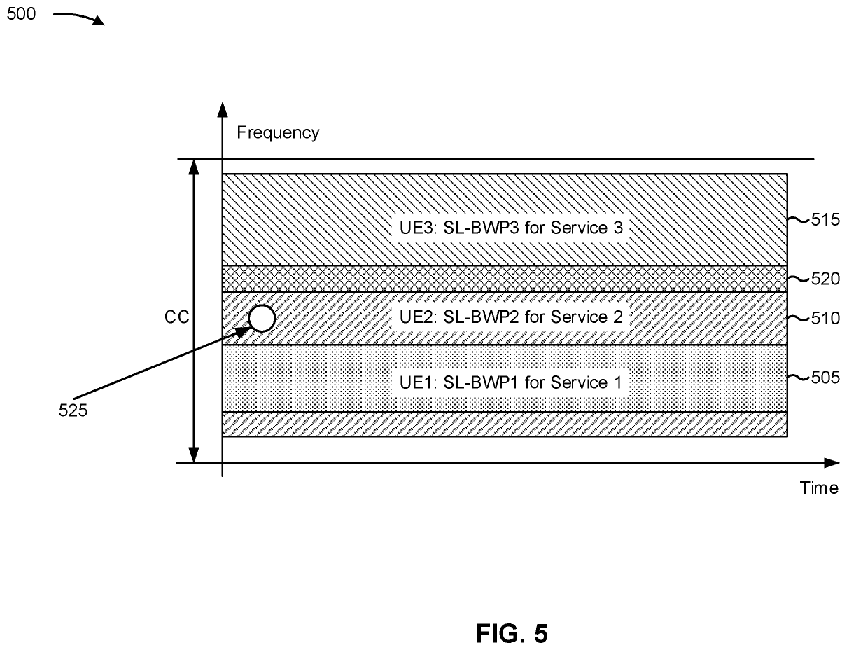

FIG. 5 is a diagram illustrating an example 500 of overlapped sidelink BWPs. A BWP is a configured set of contiguous frequency resources on which a UE (e.g., UE 120, UE 305, UE 405, UE 410) communicates. On the access link (e.g., the downlink or the uplink), a UE can be configured with up to four BWPs per carrier for the downlink and four BWPs per carrier for the uplink. BWPs may be activated or deactivated via signaling, such as medium access control (MAC) or DCI signaling. Only one downlink BWP and one uplink BWP may be active, per carrier, at a given time. The configuration information for a BWP on the radio access link may indicate a numerology, a bandwidth size, a frequency location (such as according to an NR absolute radio-frequency channel number (NR-ARFCN)), and a control resource set (CORESET). UEs may be expected to transmit and receive only within the frequency range configured for an active UL BWP and an active DL BWP respectively, and UEs may be expected to use the numerologies associated with the active BWP for such transmission or reception. On the sidelink, a single sidelink BWP may be configured and activated for all UEs on a sidelink carrier. In some aspects, only one sidelink carrier may be supported for NR V2X communications.

Example 500 shows three SL BWPs: a first SL BWP 505, a second SL BWP 510, and a third SL BWP 515. The first SL BWP 505 is associated with a first UE (UE1). The second SL BWP 510 is associated with a second UE (UE2). The third SL BWP is associated with a third UE (UE3). As shown, the first SL BWP 505 is included within the second SL BWP 510. Furthermore, as shown by reference number 520, the second SL BWP 510 and the third SL BWP 515 partially overlap each other (as indicated by the combination of left-diagonal and right-diagonal hatching used to fill the partial overlap shown by reference number 520). As used herein, “full overlap” refers to two SL BWPs that occupy the same frequency resources. “Partial overlap” refers to two SL BWPs that overlap in at least one frequency resource but not all frequency resources. For example, the first SL BWP 505 and the second SL BWP 510 partially overlap, as do the second SL BWP 510 and the third SL BWP 515.

A given UE may need to receive SCI from other UEs so that the given UE can identify resources reserved by the other UEs for their communications. If the other UEs transmit the SCI within an SL BWP of the given UE, then the given UE may be able to receive the SCI and may therefore successfully identify the resources reserved by the other UEs. Similarly, if multiple UEs are communicating in association with the same service (such as a groupcast or a broadcast), the multiple UEs may successfully receive SCI and communicate so long as the BWPs of the multiple UEs are aligned (e.g., are fully overlapped or the like). For example, with fully overlapped SL BWPs among different UEs using different services (such as different groupcast or broadcast services), or among different UE pairs (such as different unicast pairs), the participating UEs can typically receive each other's SCI.

A partially overlapped pair of SL BWPs may mean that one of the UEs associated with the partially overlapped pair of SL BWPs may be unable to receive SCI or communicate using a service associated with the partially overlapped pair of SL BWPs. For example, the second UE of example 500 may always receive SCI of the first UE of example 500 since the first SL BWP 505 is entirely included within the second SL BWP 510. However, the first UE may or may not receive SCI from the second UE, since the second UE may transmit the SCI outside of the first SL BWP 505 (but within the second SL BWP 510), such as at the location indicated by reference number 525. If the SCI is transmitted outside of the first SL BWP 505, and reserves resources that are within the first SL BWP 505, then the first UE may not be aware of the resource reservation, and may attempt to use these resources, thereby causing interference and suboptimal resource utilization. As another example, the second UE and the third UE may sometimes fail to receive each other's SCI, since the second UE or the third UE may transmit SCI outside of the partial overlap shown by reference number 520. Furthermore, if different UEs are to participate in a communication associated with a service (such as a broadcast, groupcast, or multicast), then partial overlap may be detrimental to operation of the service or may prevent communication associated with the service entirely. Thus, partial overlap between SL BWPs can lead to undetected resource reservations, diminished throughput, and decreased reliability.

Some techniques and apparatuses described herein provide cooperation between UEs regarding SL BWP configuration. For example, a first UE may detect a partial overlap between a first SL BWP of the first UE and a second SL BWP of a second UE. If the first SL BWP and the second SL BWP are associated with different services, the first UE may adjust the first SL BWP (or may switch resource pools) to eliminate the partial overlap (e.g., to make the first SL BWP and the second SL BWP non-overlapped), or the first UE may transmit an indication for the second UE to adjust the second SL BWP or switch resource pools to eliminate the partial overlap. If the first SL BWP and the second SL BWP are associated with the same service (such as for groupcast, multicast, or broadcast communication), the first UE adjust the first SL BWP (or may switch resource pools) to align the first SL BWP with the second SL BWP (e.g., to make the first SL BWP and the second SL BWP fully overlapped), or first UE may transmit an indication for the second UE to adjust the second SL BWP or switch resource pools to align the first SL BWP and the second SL BWP. Some techniques and apparatuses described herein provide for a special UE to perform similar operations for a first UE and a second UE. In this way, the occurrence of missed SCI leading to undetected resource reservations is reduced, throughput is improved, and reliability is improved.

As indicated above, FIG. 5 is provided as an example. Other examples may differ from what is described with regard to FIG. 5.

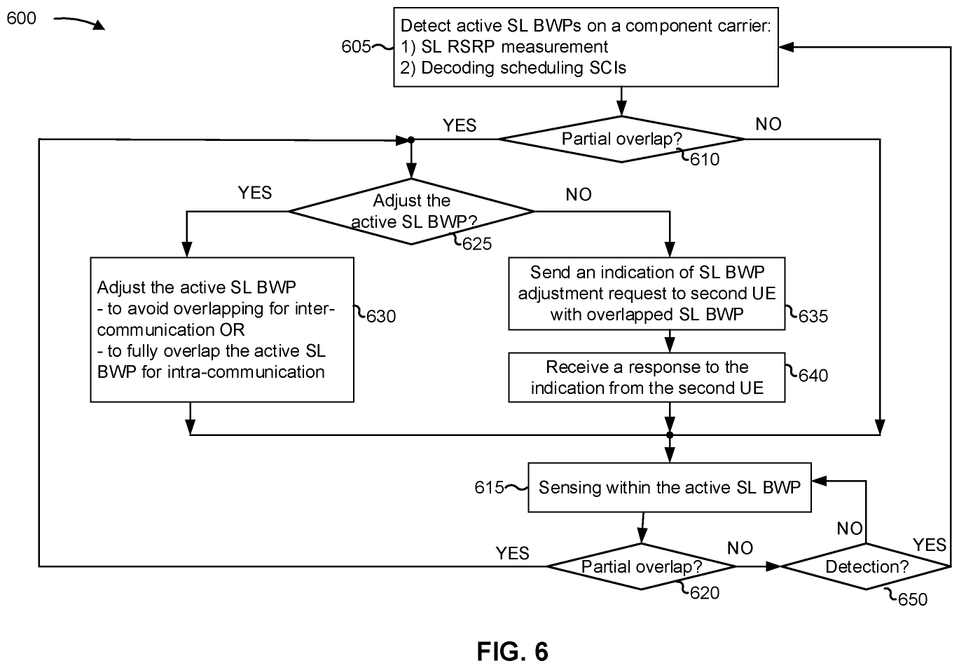

FIG. 6 is a flow diagram illustrating an example 600 of adjusting an SL BWP based at least in part on a partial overlap, in accordance with the present disclosure. The operations shown in FIG. 6 may be performed by a UE, which may be referred to as a first UE (e.g., UE 120, UE 305, UE 405, UE 410, a special UE).

As shown, the first UE may detect active SL BWPs on a component carrier (such as a sidelink carrier) (block 605). In some aspects, the first UE may detect active SL BWPs based at least in part on a measurement, such as a sidelink RSRP (e.g., PSCCH-RSRP or PSSCH-RSRP), RSSI, or CBR measurement. For example, the first UE may identify a frequency region associated with a sidelink RSRP, RSSI, or CBR measurement that satisfies a threshold and may identify a SL BWP in the frequency region based at least in part on the sidelink RSRP, RSSI, or CBR measurement satisfying the threshold (e.g., above a threshold configured or indicated by a higher layer for active SL BWP detection). Additionally, or alternatively, the first UE may detect active SL BWPs based at least in part on decoding SCI. For example, the first UE may decode SCI from a second UE scheduling communications in a frequency region and may identify a SL BWP in the frequency region based at least in part on the SCI scheduling the communications in the frequency regions. Additionally, or alternatively, the first UE may be triggered to detect active SL BWPs based at least in part on decoding SCI if a sidelink RSRP, RSSI, or CBR measurement satisfies a threshold, and may identify a possible SL BWP in the frequency region. In some aspects, the first UE may use one or more techniques in addition to or other than those described above, such as direct communication regarding SL BWPs or the like. In some aspects, the first UE may identify an SL BWP based at least in part on configuration. For example, the first UE may identify an SL BWP of the first UE based at least in part on configuration information received by the first UE configuring the SL BWP of the first UE. In example 600, the first UE identifies a first SL BWP of the first UE (e.g., an active SL BWP) and a second SL BWP of a second UE (e.g., an active SL BWP). These techniques can also be applied in scenarios where the first UE identifies multiple SL BWPs of multiple other UEs.

As further shown, the first UE may determine whether there is a partial overlap between the first SL BWP and the second SL BWP (block 610). For example, the first UE may determine whether the first SL BWP and the second SL BWP are partially overlapped but not fully overlapped. If there is no partial overlap between the first SL BWP and the second SL BWP (block 610—NO), then the first UE may perform sensing within the first SL BWP. The UE may determine, based at least in part on the sensing (e.g., decoding scheduling SCI from other UEs), whether a partial overlap is present with regard to the first SL BWP and the second SL BWP (block 620) (e.g., based at least in part on whether frequency resources indicated in the scheduling SCI from other UEs are partially within the first SL BWP). If no partial overlap is present (block 620—NO), then the UE may return to block 615. If a partial overlap is present (block 620—YES), then the UE may determine if active SL BWP detection on a carrier is needed or not (block 650). If active SL BWP detection on a carrier is needed (block 650—YES) (e.g., if the timer for periodic active SL BWP detection expires or a sidelink RSRP or a sidelink RSSI or a CBR measurement is above a threshold configured or indicated from higher layer for active SL BWP detection), then the UE may return to block 605 for detecting active SL BWPs on a component carrier. If active SL BWP detection on a carrier is not needed, (block 650—NO) (e.g., if the timer for periodic active SL BWP detection is still running or a sidelink RSRP or a sidelink RSSI or a CBR measurement is not above a threshold configured or indicated from higher layer for active SL BWP detection), then the UE may return to block 615 for sensing within the active SL BWP.

Returning to the description of block 610, if there is a partial overlap between the first SL BWP and the second SL BWP (block 610—YES), then the first UE may determine whether the first UE is to adjust the first SL BWP (e.g., the first UE's own SL BWP). For example, if there is a partial overlap and not a full overlap between the first SL BWP and the second SL BWP, then the first UE may determine whether to adjust the first SL BWP, or whether to indicate to the second UE to adjust the second SL BWP. The first UE may determine whether to adjust the first SL BWP based at least in part on resources used or needed for a data volume of the first SL BWP (e.g., whether to reduce the first SL BWP or adjust the resource pool within the first SL BWP), a priority indicated in the scheduling SCI associated with traffic in the first SL BWP or the second SL BWP (e.g., to adjust the first SL BWP if the priority associated with the first SL BWP is lower than the priority associated with the second SL BWP), respective quality of service (QoS) requirements associated with the first SL BWP and the second SL BWP (e.g., reliability, latency, data rate, etc.), a communication type indicated in the scheduling SCI associated with the traffic in the first SL BWP or the second SL BWP (e.g., to adjust the first SL BWP if unicast with the first SL BWP and groupcast or broadcast with the second SL BWP), a sidelink RSRP, RSSI, or CBR measurement (e.g., adjust the first SL BWP to the frequency range with the sidelink RSRP or RSSI or CBR measurement below a threshold configured or indicated by the higher layer for the configuration associated with the first SL BWP), or the like.

If the first UE determines to adjust the first SL BWP (block 625—YES), then the first UE may adjust the first SL BWP and may proceed to block 615 (block 630). For example, the first UE may adjust the first SL BWP to eliminate the partial overlap between the first SL BWP and the second SL BWP, such as by narrowing a bandwidth of the first SL BWP, shifting a frequency location of the first SL BWP, or the like In some aspects, the first UE may adjust the first SL BWP so that the first SL BWP is separated from or adjacent to the second SL BWP in frequency to avoid the partial overlapping. In some aspects, the first UE may adjust the first SL BWP so that a narrower BWP is included within a wider BWP (which may be useful when SCI for a communication will be transmitted on the narrower BWP) to remove partial overlapping (e.g., SL-BWP1 shown by reference number 505 with SL-BWP2 shown by reference number 510 in FIG. 5). As another example, the first UE may switch to a resource pool within the first SL BWP that is not associated with the partial overlap. The first UE may adjust the first SL BWP (or the resource pool) if the first SL BWP and the second SL BWP are associated with different services (such as if the first SL BWP is associated with a first service for peer-to-peer communication service using unicast and the second SL BWP is associated with a second service for public safety service using broadcast which is different than the first service).

In some aspects, the first UE may adjust the first SL BWP so that the first SL BWP and the second SL BWP are aligned with each other (such as so that the first SL BWP and the second SL BWP are fully overlapped for the same communication of a service). The first UE may adjust the first SL BWP so that the first SL BWP and the second SL BWP are aligned with each other in cases where the first SL BWP and the second SL BWP are associated with a same service, such as for unicast, groupcast/multicast, or broadcast communication. Thus, the first UE may facilitate the communication by aligning SL BWPs of different UEs with each other.

If the first UE determines not to adjust the first SL BWP (block 625—NO) (e.g., due to QoS requirement such as priority, latency, reliability, data rate or data volume, etc., or unavailable frequency resources for the adjustment, or cast type such as a broadcast with all UEs in a proximity), then the first UE may transmit an indication to the second UE (block 635). The indication may indicate for the second UE to adjust the second SL BWP. The indication is described in more detail elsewhere herein. In some aspects, the indication may indicate an overlapped region of the first SL BWP and the second SL BWP, such that the second UE can adjust the second SL BWP (or a resource pool) to eliminate the overlapped region (such as for SL BWPs associated with different services). In some aspects, the indication may indicate one or more parameters of the first SL BWP, such that the second UE can adjust the second SL BWP (or a resource pool) to align with the first SL BWP (such as for SL BWPs associated with the same service). In some aspects, the second UE may adjust the second SL BWP (or a resource pool) in accordance with the indication (not shown in FIG. 6). In some aspects, the second UE may not adjust the second SL BWP (or a resource pool) in accordance with the indication (also not shown in FIG. 6).

As shown, the first UE may receive a response to the indication (block 640) and may proceed to block 615. In some aspects, the response may indicate that the indication was received (e.g., an acknowledgment or negative acknowledgment). In some aspects, the response may indicate that the second UE adjusted the second SL BWP (or a resource pool). In some aspects, the response may indicate a manner in which the second UE adjusted the second SL BWP (such as one or more parameters that were adjusted, which may include a bandwidth size, a frequency center, or the like). In some aspects, the response may indicate that the second SL BWP was not adjusted. In some aspects, if the response indicates that the second SL BWP was not adjusted, then the first UE may return to block 630. In this way, the first UE may adjust the first SL BWP or may indicate for the second UE to adjust the second SL BWP. Thus, the first UE may eliminate a partial overlap (in the case of SL BWPs associated with different services) or align SL BWPs (in the case of SL BWPs associated with the same service), which improves throughput, improves resource reservation detection, and improves reliability.

As indicated above, FIG. 6 is provided as an example. Other examples may differ from what is described with regard to FIG. 6.

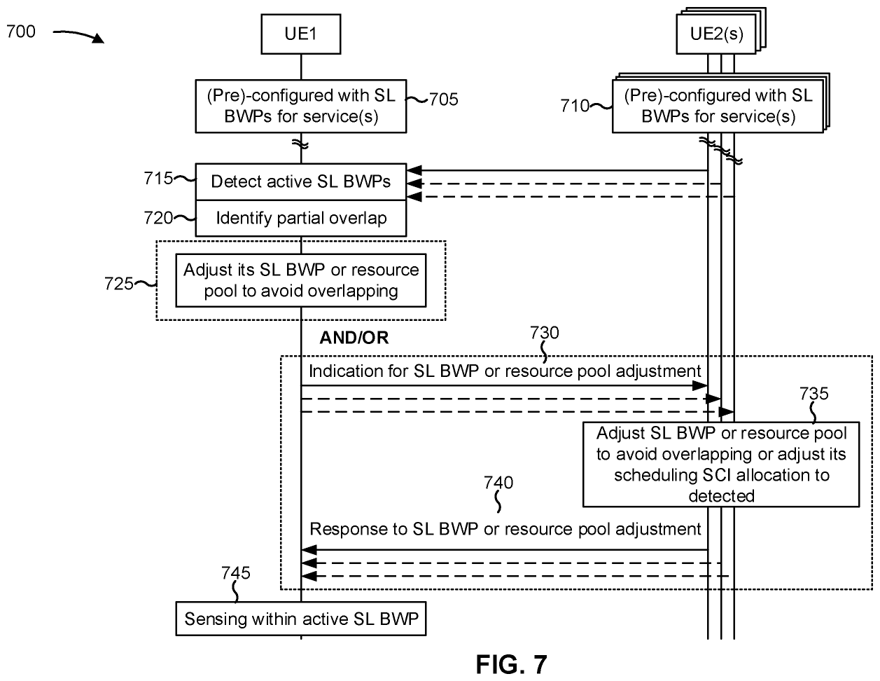

FIG. 7 is a diagram illustrating an example 700 of signaling associated with adjustment of an SL BWP to eliminate a partial overlap, in accordance with the present disclosure. Example 700 includes a first UE (shown as UE1, and which may include UE 120, UE 305, UE 405, or UE 410) and one or more second UEs (shown as UE2, and which may include UE 120, UE 305, UE 405, or UE 410). Example 700 relates to a case where two SL BWPs associated with different communications or services are partially overlapped, such that a UE (e.g., the first UE or a second UE) may eliminate the partial overlap (e.g., removing the partial overlap for inter-communication), thereby reducing the occurrence of missing an SCI outside of an SL BWP (e.g., the monitoring active SL BWP) that schedules a communication in the other SL BWP.

As shown by reference numbers 705 and 710, the first UE and the one or more second UEs may be configured with respective SL BWPs. In some aspects, each UE, of the first UE and the one or more second UEs, may be configured with an SL BWP. In some other aspects, a UE, of the first UE and the one or more second UEs, may be configured with multiple SL BWPs. In other words, the techniques described herein are not limited to implementations where a UE can be configured with only one SL BWP. The configuration of the respective SL BWPs may indicate, for example, a service associated with an SL BWP, a carrier associated with the SL BWP, a bandwidth size of the SL BWP, a frequency location of the SL BWP, a numerology of the SL BWP, one or multiple resource pools within the SL BWP, or other parameters. In some aspects, the first UE and/or the one or more second UEs may be pre-configured with the respective SL BWPs, such as pre-configured via manufacturer, V2X service provider, or a base station while under the base station's coverage, or the like. Additionally, or alternatively, the first UE and/or the one or more second UEs may be configured with the respective SL BWPs, such as via a base station on a radio access link (e.g., using system information or dedicated RRC message on MAC CE on the access link shown in FIG. 4) or a special UE on sidelink (e.g., RSU, a group lead, a cluster head or a scheduling UE using SL RRC signaling or SL MAC CE). In some aspects, the first UE and/or the one or more second UEs may determine the respective SL BWPs based on the information for SL BWP configuration pre-configured or configured.

As shown by reference number 715, the first UE may detect active SL BWPs. For example, the first UE may detect a first SL BWP of the first UE and one or more second SL BWPs of the one or more second UEs, where the one or more second SL BWPs and the first SL BWP are active BWPs. The detection of active SL BWPs is described in more detail in connection with FIG. 6. As shown by reference number 720, the first UE may detect a partial overlap between the first SL BWP and an SL BWP of the one or more second SL BWPs. The detection of the partial overlap is also described in more detail in connection with FIG. 6.

As shown by reference number 725, in some aspects, the first UE may adjust the first SL BWP (or a resource pool of the first UE) to eliminate the partial overlap. For example, the first UE may adjust one or more parameters of the first SL BWP such that the first SL BWP and the identified second SL BWP do not overlap. As another example, the first UE may switch to a resource pool that excludes resources of the partial overlap. As another example, if the first SL BWP is a narrow band, the first UE may adjust the first SL BWP so that the first SL BWP is fully included in the identified second SL BWP. In some aspects, if the first SL BWP partially overlaps with multiple second BWPs, the first UE may adjust the first SL BWP so that the first SL BWP no longer partially overlaps with any of the multiple second BWPs. Additionally, or alternatively, the first UE may adjust the frequency resource allocation used by the first UE to transmit scheduling SCI. For example, the first UE may adjust the location in frequency within the first SL BWP so that the scheduling SCI is transmitted in the partially overlapped region of the first SL BWP and the second SL BWP, thus enabling the second UE to identify resource reservations of the first UE. In some aspects, if the first SL BWP partially overlaps with multiple second BWPs, the first UE may replicate the scheduling SCI in each partially overlapped region of the first SL BWP and multiple second SL BWPs, thus enabling each of second UEs to identify resource reservations of the first UE. For another example, the first UE may adjust the location in frequency within the first SL BWP so that the scheduling SCI received from other UEs may be relayed or forwarded in the partially overlapped region of the first SL BWP and the second SL BWP, thus enabling the second UE to identify resource reservations of the other UEs.

As shown by reference number 730, in some other aspects, the first UE may transmit an indication to a second UE associated with the identified second SL BWP (e.g., transmitting the indication on a default SL BWP or a common SL BWP shared by UEs in the proximity or transmitting the indication using the resources within the overlapped frequency range). For example, the indication may indicate for the second UE to adjust the second SL BWP or to switch a resource pool such that the partial overlap between the first SL BWP and the second SL BWP is eliminated. In some aspects, the indication may be referred to as an SL BWP adjustment indication. In some aspects, the first UE may transmit the indication via a sidelink MAC CE. In some aspects, the first UE may transmit the indication via a UE assistance information message, such as via a UEAssistancelnformationSidelink message. In some other aspects, the first UE may transmit the indication via an RRC message, such as an RRC reconfiguration (e.g., RRCReconfigurationSidelink) message. In some aspects, if multiple second BWPs associated with multiple second UEs partially overlap the first SL BWP, the first UE may transmit the indication to the multiple second UEs (e.g., transmitting the indication on a default SL BWP or a common SL BWP shared by UEs in the proximity or transmitting the indication separately using the resources within each overlapped frequency range). Thus, the first UE may reduce the occurrence of missed resource reservations at the first UE, thereby increasing throughput and improving reliability of sidelink communications. In some other aspects, the first UE may transmit an indication to a second UE associated with the identified second SL BWP (e.g., transmitting the indication on a default SL BWP or a common SL BWP shared by UEs in the proximity or transmitting the indication using the resources within the overlapped frequency range). For example, the indication may indicate to the second UE the adjustment to the first SL BWP or to resource pool within the first SL BWP made by the first UE such that the partial overlap between the first SL BWP and the second SL BWP is eliminated.

As shown by reference number 735, in some aspects, the second UE may adjust the second SL BWP. For example, the second UE may adjust one or more parameters of the second SL BWP so that the second SL BWP no longer partially overlaps with the first SL BWP. As another example, if the second SL BWP is a narrow band, the second UE may adjust the second SL BWP so that the second SL BWP is fully included in the first SL BWP. Additionally, or alternatively, the second UE may switch a resource pool. For example, the second UE may switch to a resource pool that does not include overlapped resources of the first SL BWP and the second SL BWP. Additionally, or alternatively, the second UE may adjust the frequency resource allocation used by the second UE to transmit scheduling SCI. For example, the second UE may adjust the location in frequency within the second SL BWP so that the scheduling SCI is transmitted in the partially overlapped region of the first SL BWP and the second SL BWP, thus enabling the first UE to identify resource reservations of the second UE. Thus, the second UE may reduce the occurrence of missed resource reservations at the first UE, thereby increasing throughput and improving reliability of sidelink communications. For another example, the second UE may adjust the location in frequency within the second SL BWP so that the scheduling SCI received from other UEs may be relayed or forwarded in the partially overlapped region of the first SL BWP and the second SL BWP, thus enabling the first UE to identify resource reservations of the other UEs.

As shown by reference number 740, the second UE may transmit a response to the indication (e.g., transmitting the response on a default SL BWP or a common SL BWP shared by UEs in the proximity or transmitting the response using the resources within each overlapped frequency range before switching to the adjusted second SL BWP). In some aspects, the response may indicate that the second SL BWP is adjusted. In some aspects, the response may indicate a manner in which the second SL BWP is adjusted (e.g., one or more parameters that were adjusted). In some aspects, the response may indicate that the second UE switched to a resource pool that eliminates the partial overlap. In some aspects, the response may indicate that the second UE adjusted a scheduling SCI location. In some other aspects, the response may not indicate that the second UE adjusted the scheduling SCI location. For example, the response may indicate that the indication was received (or no response may be transmitted), and the second UE may adjust the scheduling SCI location without explicitly indicating the adjustment to the first UE. In some aspects, the response may be transmitted via an ACK/NACK to the indication transmitted with a sidelink medium access control (MAC) control element (CE). In some aspects, the response may be transmitted via a UE assistance information message, such as via a UEAssistancelnformationSidelink message. In some other aspects, the second UE may transmit the response via an RRC message, such as an RRC reconfiguration complete (e.g., RRCReconfigurationCompleteSidelink) message. In some aspects, if the first UE transmits the indication to multiple second UEs, the first UE may receive responses from the multiple second UEs.

As shown by reference number 745, the first UE may conduct sensing in the first SL BWP. For example, the first UE may perform sensing for resource selection or other operations within the first SL BWP. In some aspects, the first UE may communicate with other UEs participating in the communication of a service on the first SL BWP as adjusted. In this way, the first UE and/or the one or more second UEs may reduce the occurrence of missed resource reservations, improve throughput, and improve reliability of the sidelink network.

As indicated above, FIG. 7 is provided as an example. Other examples may differ from what is described with regard to FIG. 7.

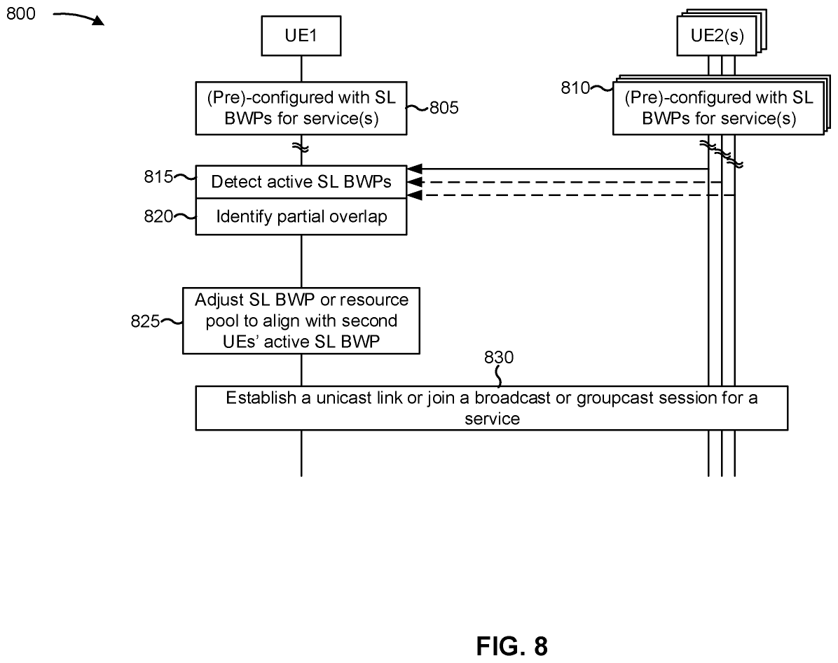

FIG. 8 is a diagram illustrating an example 800 of signaling associated with adjustment of an SL BWP to align partially overlapped SL BWPs, in accordance with the present disclosure. Example 800 includes a first UE (shown as UE1, and which may include UE 120, UE 305, UE 405, or UE 410) and one or more second UEs (shown as UE2, and which may include UE 120, UE 305, UE 405, or UE 410). Example 800 relates to a case where two SL BWPs associated with the same service are partially overlapped (e.g., when one or more UEs are to determine a SL BWP for a service with pre-configured information for SL BWP configuration or when the one or more UEs are at an initial stage to join a communication of a service). A UE (e.g., the first UE or a second UE) may align the two SL BWPs with each other, thereby enabling the first UE and the second UE to use the same service.

As shown by reference numbers 805 and 810, the first UE and the one or more second UEs may be configured with respective SL BWPs. In some aspects, each UE, of the first UE and the one or more second UEs, may be configured with an SL BWP. In some other aspects, a UE, of the first UE and the one or more second UEs, may be configured with multiple SL BWPs. In other words, the techniques described herein are not limited to implementations where a UE can be configured with only one SL BWP. The configuration of the respective SL BWPs may indicate, for example, a service associated with an SL BWP, a carrier associated with the SL BWP, a bandwidth size of the SL BWP, a frequency location of the SL BWP, a numerology of the SL BWP, one or multiple resource pools within the SL BWP, or other parameters. In some aspects, the first UE and/or the one or more second UEs may be pre-configured with the respective SL BWPs, such as pre-configured via manufacture, V2X service provider, or a base station while under the base station's coverage, or the like. Additionally, or alternatively, the first UE and/or the one or more second UEs may be configured with the respective SL BWPs, such as via a base station on radio access link (e.g., using system information or dedicated RRC message or MAC CE on the access link shown in FIG. 4) or a special UE on sidelink (e.g., RSU, a group lead, a cluster head or a scheduling UE using SL RRC signaling or SL MAC CE). In some aspects, the first UE and/or the one or more second UEs may determine the respective SL BWPs based on the information for SL BWP configuration pre-configured or configured.

As shown by reference number 815, the first UE may detect active SL BWPs. For example, the first UE may detect a first SL BWP of the first UE and one or more second SL BWPs of the one or more second UEs, where the one or more second SL BWPs and the first SL BWP are active BWPs. The detection of active SL BWPs is described in more detail in connection with FIG. 6. As shown by reference number 820, the first UE may detect a partial overlap between the first SL BWP and an SL BWP of the one or more second SL BWPs. The detection of the partial overlap is also described in more detail in connection with FIG. 6.

As shown by reference number 825, in some aspects, the first UE may adjust the first SL BWP (or a resource pool of the first UE) so that the first SL BWP and the second SL BWP are aligned. For example, the first UE may adjust one or more parameters of the first SL BWP such that the first SL BWP and the identified second SL BWP fully overlap, or so that one of the first SL BWP and the second SL BWP is included within the other of the first SL BWP or the second SL BWP. As another example, the first UE may switch to a resource pool that aligns with (e.g., fully overlaps with or is included in) the second SL BWP. In some aspects, if the first SL BWP partially overlaps with multiple second BWPs, the first UE may adjust the first SL BWP so that the first SL BWP no longer partially overlaps with any of the multiple second BWPs. In some aspects, second SL BWPs of multiple second UEs may be aligned with each other, such as if the multiple second UEs are each associated with the same service. In this case, the first UE may align the first SL BWP (or switch to an aligned resource pool) with each of the second SL BWPs. Additionally, or alternatively, in some aspects, the first UE may transmit an indication to one or more second UEs associated with the identified second SL BWP(s) (e.g., transmitting the indication on a default SL BWP or a common SL BWP shared by UEs in the proximity or transmitting the indication using the resources within the overlapped frequency range). For example, the indication may indicate for the one or more second UEs to adjust the second SL BWP(s) or to switch a resource pool (e.g., as described in FIG. 7) such that the first SL BWP and the second SL BWP(s) are fully aligned. For another example, the indication may indicate to the second UE the adjustment to the first SL BWP or to resource pool within the first SL BWP made by the first UE such that the first SL BWP is fully aligned with the second SL BWP.

As shown by reference number 830, the first UE may communicate on the first SL BWP. In some aspects, the first UE may establish a unicast session with a second UE (e.g., a second UE associated with a second SL BWP that is aligned with the first SL BWP). In some aspects, the first UE may join a broadcast or groupcast session associated with one or more second UEs (e.g., where the broadcast or groupcast session is associated with a second SL BWP with which the first SL BWP is aligned). In this way, the first UE and/or the one or more second UEs may reduce the occurrence of missed resource reservations, improve throughput, and improve reliability of the sidelink network.

As indicated above, FIG. 8 is provided as an example. Other examples may differ from what is described with regard to FIG. 8.

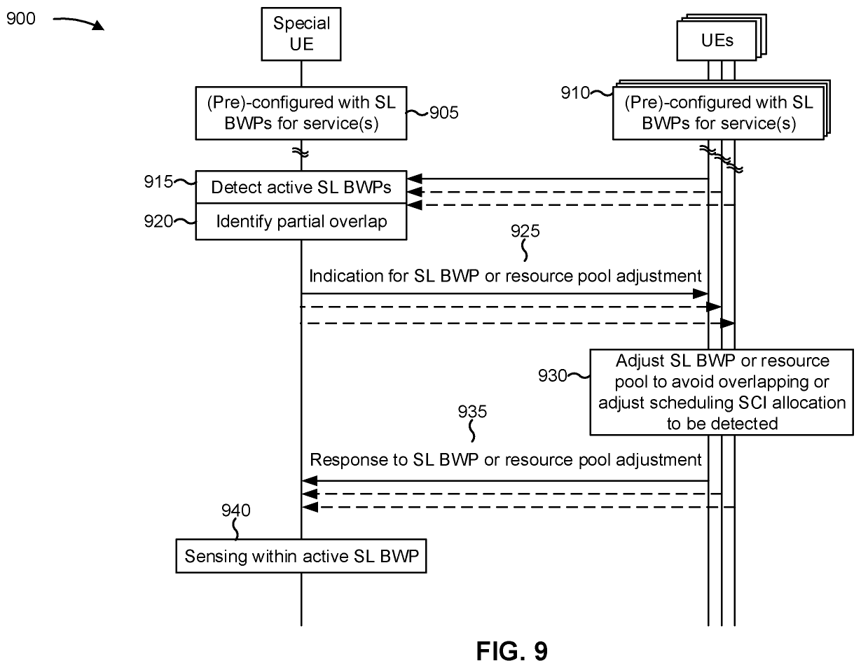

FIG. 9 is a diagram illustrating an example 900 of signaling associated with adjustment of an SL BWP by a special UE (e.g., an RSU, a group lead, a cluster head, a scheduling UE, etc.), in accordance with the present disclosure. Example 900 includes a special UE (which may include UE 120, UE 305, UE 405, UE 410, or the special UE described elsewhere herein) and a plurality of UEs (which may include UE 120, UE 305, UE 405, or UE 410). Example 900 relates to a case where two or more SL BWPs are partially overlapped, and the special UE detects the partial overlap and causes one or more of the plurality of UEs to adjust an SL BWP, thereby eliminating the partial overlap or aligning the SL BWPs.

As shown by reference numbers 905 and 910, the special UE and the plurality of UEs may be configured with respective SL BWPs. In some aspects, each UE, of the special UE and the plurality of UEs, may be configured with an SL BWP. In some other aspects, a UE, of the special UE and the plurality of UEs, may be configured with multiple SL BWPs. In other words, the techniques described herein are not limited to implementations where a UE can be configured with only one SL BWP. The configuration of the respective SL BWPs may indicate, for example, a service associated with an SL BWP, a carrier associated with the SL BWP, a bandwidth size of the SL BWP, a frequency location of the SL BWP, a numerology of the SL BWP, one or multiple resource pools within the SL BWP, or other parameters. In some aspects, the special UE and/or the one or more UEs may be pre-configured with the respective SL BWPs, such as pre-configured via manufacture, a V2X service provider, a base station while under the base station's coverage, or the like. Additionally, or alternatively, the special UE and/or the plurality of UEs may be configured with the respective SL BWPs, such as a base station on radio access link (e.g., using system information or dedicated RRC message on MAC CE on the access link shown in FIG. 4) or a special UE on sidelink (e.g., RSU, a group lead, a cluster head or a scheduling UE using SL RRC signaling or SL MAC CE). In some aspects, the first UE and/or the one or more second UEs may determine the respective SL BWPs based on the information for SL BWP configuration pre-configured or configured.

As shown by reference number 915, the special UE may detect active SL BWPs. For example, the special UE may detect a first SL BWP of a first UE of the plurality of UEs and a second SL BWP of a second UE of the plurality of UEs, where the second SL BWP and the first SL BWP are active BWPs. It should be understood that the first UE and the second UE can be any UE of the plurality of UEs. The detection of active SL BWPs is described in more detail in connection with FIG. 6. As shown by reference number 920, the special UE may detect a partial overlap between the first SL BWP and the second SL BWP. In some aspects, the special UE may detect a partial overlap between three or more SL BWPs. The detection of the partial overlap is also described in more detail in connection with FIG. 6.

As shown by reference number 925, the special UE may transmit an indication to the first UE associated with the first SL BWP (e.g., transmitting the indication on a default SL BWP or a common SL BWP shared by UEs in the proximity or transmitting the indication using the resources within the overlapped frequency range). For example, the indication may indicate for the first UE to adjust the first SL BWP or to switch a resource pool such that the partial overlap between the first SL BWP and the second SL BWP is eliminated for inter-communication (e.g., different communication of difference services). As another example, the indication may indicate for the first UE to adjust the first SL BWP or switch the resource pool such that the first SL BWP is aligned with the second SL BWP for intra-communication (e.g., a communication of a service). As another example, if the first SL BWP is a narrow band, the first UE may adjust the first SL BWP so that the first SL BWP is fully included in the identified second SL BWP. As another example, the indication may indicate for the first UE to relay or forward the communication in the first SL BWP to another SL BWP(s) (e.g., replay or forward a broadcast communication in a proximity received within the first SL BWP to the other SL BWP(s) detected for UE(s) having limited capability of SL BWP allocation). In some aspects, the indication may be referred to as an SL BWP adjustment or communication relaying or forwarding indication. In some aspects, the special UE may transmit the indication via a UE assistance information message, such as via a UEAssistancelnformationSidelink message. In some other aspects, the special UE may transmit the indication via an RRC message, such as an RRC reconfiguration (e.g., RRCReconfigurationSidelink) message. In some aspects, the special UE may transmit the indication via sidelink MAC signaling, such as a sidelink MAC message (e.g., a MAC control element). In some aspects, if multiple second BWPs associated with multiple UEs partially overlap the first SL BWP, the special UE may transmit the indication to the multiple UEs. Thus, the special UE may reduce the occurrence of missed resource reservations at the first UE, thereby increasing throughput and improving reliability of sidelink communications.

As shown by reference number 930, in some aspects, the first UE may adjust the first SL BWP. For example, the first UE may adjust one or more parameters of the first SL BWP so that the first SL BWP no longer partially overlaps with the second SL BWP. As another example, the first UE may adjust one or more parameters of the first SL BWP so that the first SL BWP is aligned with the second SL BWP. As another example, if the first SL BWP is a narrow band, the first UE may adjust the first SL BWP so that the first SL BWP is fully included in the identified second SL BWP. Additionally, or alternatively, the first UE may switch a resource pool. For example, the first UE may switch to a resource pool that does not include overlapped resources of the first SL BWP and the second SL BWP, or that is aligned with the second SL BWP. Additionally, or alternatively, the first UE may adjust a location used by the first UE to transmit SCI. For example, the first UE may adjust the location so that the SCI is transmitted in the partially overlapped region of the first SL BWP and the second SL BWP, thus enabling the second UE to identify resource reservations of the first UE. In some aspects, if the first SL BWP partially overlaps with multiple second BWPs, the first UE may replicate the scheduling SCI in each partially overlapped region of the first SL BWP and multiple second SL BWPs, thus enabling each of second UEs to identify resource reservations of the first UE. For another example, the first UE may adjust the location in frequency within the first SL BWP so that the scheduling SCI received from other UEs may be relayed or forwarded in the partially overlapped region of the first SL BWP and the second SL BWP, thus enabling the second UE to identify resource reservations of the other UEs. Additionally, or alternatively, the first UE may make one or multiple adjustments to the first SL BWP thus enabling the first UE to relay or forward data communication within one SL BWP to another SL BWP. Thus, the special UE may reduce the occurrence of missed resource reservations among the UEs, thereby increasing throughput and improving reliability of sidelink communications.

As shown by reference number 935, the first UE may transmit a response to the indication (e.g., transmitting the response on a default SL BWP or a common SL BWP shared by UEs in the proximity or transmitting the response using the resources within each overlapped frequency range before switching to the adjusted second SL BWP). In some aspects, the response may indicate that the first SL BWP is adjusted. In some aspects, the response may indicate a manner in which the first SL BWP is adjusted (e.g., one or more parameters that were adjusted). In some aspects, the response may indicate that the first UE switched to a resource pool that eliminates the partial overlap. In some aspects, the response may indicate that the first UE adjusted a scheduling SCI location. In some other aspects, the response may not indicate that the first UE adjusted the scheduling SCI location. For example, the response may indicate that the indication was received (or no response may be transmitted), and the first UE may adjust the scheduling SCI location without explicitly indicating the adjustment to the special UE. In some aspects, the response may be transmitted via an ACK/NACK to the indication transmitted with a sidelink MAC CE. In some aspects, the response may be transmitted via a UE assistance information message, such as via a UEAssistancelnformationSidelink message. In some other aspects, the first UE may transmit the response via an RRC message, such as an RRC reconfiguration complete (e.g., RRCReconfigurationCompleteSidelink) message. In some aspects, if the special UE transmits the indication to multiple UEs of the plurality of UEs, the special UE may receive responses from the multiple UEs.

As shown by reference number 940, the special UE may conduct sensing in a SL BWP. For example, the special UE may perform sensing for resource selection, identification of partial overlaps or SL BWPs, or other operations of the special UE. In this way, the special UE may reduce the occurrence of missed resource reservations, improve throughput, and improve reliability of the sidelink network.

As indicated above, FIG. 9 is provided as an example. Other examples may differ from what is described with regard to FIG. 9.

FIG. 10 is a diagram illustrating an example process 1000 performed, for example, by a UE, in accordance with the present disclosure. Example process 1000 is an example where a first UE (e.g., UE 120, UE 305, UE 405, UE 410, the first UE of FIGS. 7-8) performs cooperative operation for a sidelink bandwidth part.

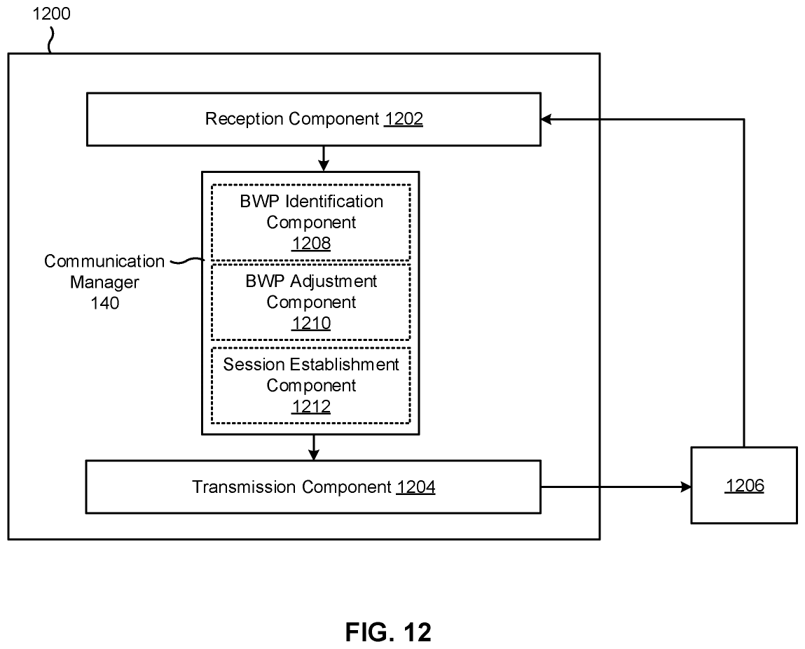

As shown in FIG. 10, in some aspects, process 1000 may include identifying a first SL BWP of the first UE and a second SL BWP of a second UE (block 1010). For example, the first UE (e.g., using communication manager 140 and/or BWP identification component 1208, depicted in FIG. 12) may identify a first SL BWP of the first UE and a second SL BWP of a second UE, as described above.

As further shown in FIG. 10, in some aspects, process 1000 may include making an adjustment associated with the first SL BWP based at least in part on a partial overlap between the first SL BWP and the second SL BWP (block 1020). For example, the UE (e.g., using communication manager 140 and/or BWP adjustment component 1210, depicted in FIG. 12) may make an adjustment associated with the first SL BWP based at least in part on a partial overlap between the first SL BWP and the second SL BWP, as described above. “Making an adjustment associated with the first SL BWP” may include adjusting the first SL BWP or adjusting a resource pool associated with the first SL BWP.

As further shown in FIG. 10, in some aspects, process 1000 may include transmitting, to the second UE based at least in part on the partial overlap between the first SL BWP and the second SL BWP, an indication associated with adjusting the second SL BWP (block 1030). For example, the UE (e.g., using communication manager 140 and/or transmission component 1204, depicted in FIG. 12) may transmit, to the second UE based at least in part on the partial overlap between the first SL BWP and the second SL BWP, an indication associated with adjusting the second SL BWP, as described above. In some aspects, the first UE may perform only one of block 1020 or block 1030. In some other aspects, the first UE may perform both of blocks 1020 and 1030. For example, the first UE may transmit an indication for the second UE to adjust the second SL BWP, and if the second UE does not adjust the second SL BWP, then the first UE may adjust the first SL BWP. For another example, the first UE may transmit an indication to the second UE with the adjustment made with the first SL BWP by the first UE and the first SL BWP is not partially overlapped with the second SL BWP for inter-communication as exemplified in FIG. 7 or the first SL BWP is aligned with the second SL BWP for intra-communication as exemplified in FIG. 8.

Process 1000 may include additional aspects, such as any single aspect or any combination of aspects described below and/or in connection with one or more other processes described elsewhere herein.

In a first aspect, the first SL BWP is associated with a first service and the second SL BWP is associated with a second service different than the first service.

In a second aspect, alone or in combination with the first aspect, adjusting the first SL BWP based at least in part on the partial overlap between the first SL BWP and the second SL BWP comprises switching to a resource pool that is not associated with the partial overlap.

In a third aspect, alone or in combination with one or more of the first and second aspects, the indication is provided via a UE assistance information message, a radio resource control message, or medium access control signaling via a PC5 interface.

In a fourth aspect, alone or in combination with one or more of the first through third aspects, process 1000 includes receiving a response associated with the indication, wherein the response indicates that the second SL BWP was adjusted.

In a fifth aspect, alone or in combination with one or more of the first through fourth aspects, process 1000 includes receiving a response associated with the indication, wherein the response indicates that the second UE switched to a resource pool that is not associated with the partial overlap.

In a sixth aspect, alone or in combination with one or more of the first through fifth aspects, process 1000 includes receiving a response associated with the indication, wherein the response indicates that the second UE adjusted a location of sidelink control information to be included in the partial overlap.

In a seventh aspect, alone or in combination with one or more of the first through sixth aspects, the first SL BWP and the second SL BWP are associated with a same service.

In an eighth aspect, alone or in combination with one or more of the first through seventh aspects, adjusting the first SL BWP based at least in part on the partial overlap between the first SL BWP and the second SL BWP further comprises adjusting the first SL BWP or a resource pool associated with the first SL BWP to align the first SL BWP with the second SL BWP.

In a ninth aspect, alone or in combination with one or more of the first through eighth aspects, process 1000 includes establishing a unicast session with the second UE after adjusting the first SL BWP.

In a tenth aspect, alone or in combination with one or more of the first through ninth aspects, process 1000 includes joining a broadcast or a groupcast session associated with one or more UEs including the second UE.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a network node, in accordance with the present disclosure. Example process 1100 is an example where the network node (e.g., UE 120, UE 305, UE 405, UE 410, the special UE of FIG. 9) performs cooperative operation for a sidelink bandwidth part.

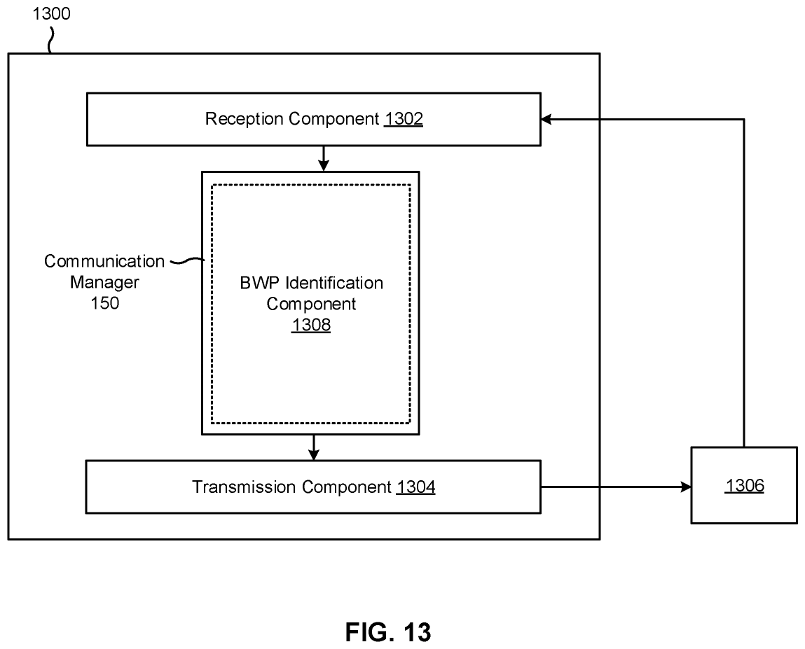

As shown in FIG. 11, in some aspects, process 1100 may include identifying a first SL BWP of a first UE and a second SL BWP of a second UE (block 1110). For example, the network node (e.g., using communication manager 150 and/or BWP identification component 1308, depicted in FIG. 13) may identify a first SL BWP of a first UE and a second SL BWP of a second UE, as described above.

As further shown in FIG. 11, in some aspects, process 1100 may include transmitting, to the first UE based at least in part on a partial overlap between the first SL BWP and the second SL BWP, an indication associated with adjusting the first SL BWP (block 1120). For example, the network node (e.g., using communication manager 150 and/or transmission component 1304, depicted in FIG. 13) may transmit, to the first UE based at least in part on a partial overlap between the first SL BWP and the second SL BWP, an indication associated with adjusting the first SL BWP, as described above.

Process 1100 may include additional aspects, such as any single aspect or any combination of aspects described below and/or in connection with one or more other processes described elsewhere herein.

In a first aspect, the first SL BWP and the second SL BWP are associated with different services.

In a second aspect, alone or in combination with the first aspect, the first SL BWP and the second SL BWP are associated with a same service.

In a third aspect, alone or in combination with one or more of the first and second aspects, the indication is provided via a UE assistance information message, a radio resource control message, or a medium access control message.

In a fourth aspect, alone or in combination with one or more of the first through third aspects, process 1100 includes receiving a response associated with the indication, wherein the response indicates that the first SL BWP was adjusted.

In a fifth aspect, alone or in combination with one or more of the first through fourth aspects, process 1100 includes receiving a response associated with the indication, wherein the response indicates that the first UE switched to a resource pool that is not associated with the partial overlap.

In a sixth aspect, alone or in combination with one or more of the first through fifth aspects, process 1100 includes receiving a response associated with the indication, wherein the response indicates that the first UE adjusted a location of sidelink control information to be included in the partial overlap.

In a seventh aspect, alone or in combination with one or more of the first through sixth aspects, process 1100 includes receiving a response associated with the indication, wherein the response indicates that the first UE adjusted the first SL BWP or a resource pool associated with the first SL BWP to align the first SL BWP with the second SL BWP.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication. The apparatus 1200 may be a UE (e.g., the first UE of FIG. 6, 7, 8, or 10), or a UE may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include the communication manager 140. The communication manager 140 may include one or more of a BWP identification component 1208, a BWP adjustment component 1210, or a session establishment component 1212, among other examples.

In some aspects, the apparatus 1200 may be configured to perform one or more operations described herein in connection with FIGS. 3-9. Additionally, or alternatively, the apparatus 1200 may be configured to perform one or more processes described herein, such as process 1000 of FIG. 10, or a combination thereof. In some aspects, the apparatus 1200 and/or one or more components shown in FIG. 12 may include one or more components of the UE described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the UE described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the UE described in connection with FIG. 2. In some aspects, the transmission component 1204 may be co-located with the reception component 1202 in a transceiver.

The BWP identification component 1208 may identify a first SL BWP of the first UE and a second SL BWP of a second UE. The BWP adjustment component 1210 may adjust the first SL BWP based at least in part on a partial overlap between the first SL BWP and the second SL BWP. The transmission component 1204 may transmit, to the second UE based at least in part on the partial overlap between the first SL BWP and the second SL BWP, an indication associated with adjusting the second SL BWP.

The reception component 1202 may receive a response associated with the indication, wherein the response indicates that the second SL BWP was adjusted.

The reception component 1202 may receive a response associated with the indication, wherein the response indicates that the second UE switched to a resource pool that is not associated with the partial overlap.

The reception component 1202 may receive a response associated with the indication, wherein the response indicates that the second UE adjusted a location of sidelink control information to be included in the partial overlap.

The session establishment component 1212 may establish a unicast session with the second UE after adjusting the first SL BWP.

The session establishment component 1212 may join a broadcast or a groupcast session associated with one or more UEs including the second UE.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a diagram of an example apparatus 1300 for wireless communication, in accordance with the present disclosure. The apparatus 1300 may be a network node such as a special UE (e.g., the special UE of FIG. 9 or 11), or a network node may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, or another wireless communication device) using the reception component 1302 and the transmission component 1304. As further shown, the apparatus 1300 may include the communication manager 140. The communication manager 140 may include a BWP identification component 1308, among other examples.

In some aspects, the apparatus 1300 may be configured to perform one or more operations described herein in connection with FIGS. 3-9. Additionally, or alternatively, the apparatus 1300 may be configured to perform one or more processes described herein, such as process 1100 of FIG. 11, or a combination thereof. In some aspects, the apparatus 1300 and/or one or more components shown in FIG. 13 may include one or more components of the UE described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the UE described in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the UE described in connection with FIG. 2. In some aspects, the transmission component 1304 may be co-located with the reception component 1302 in a transceiver.

The BWP identification component 1308 may identify a first SL BWP of a first UE and a second SL BWP of a second UE. The transmission component 1304 may transmit, to the first UE based at least in part on a partial overlap between the first SL BWP and the second SL BWP, an indication associated with adjusting the first SL BWP.

The reception component 1302 may receive a response associated with the indication, wherein the response indicates that the first SL BWP was adjusted.

The reception component 1302 may receive a response associated with the indication, wherein the response indicates that the first UE switched to a resource pool that is not associated with the partial overlap.

The reception component 1302 may receive a response associated with the indication, wherein the response indicates that the first UE adjusted a location of sidelink control information to be included in the partial overlap.

The reception component 1302 may receive a response associated with the indication, wherein the response indicates that the first UE adjusted the first SL BWP or a resource pool associated with the first SL BWP to align the first SL BWP with the second SL BWP.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:

Aspect 1: A method of wireless communication performed by a first user equipment (UE), comprising: identifying a first sidelink (SL) bandwidth part (BWP) of the first UE and a second SL BWP of a second UE; and one of: adjusting the first SL BWP based at least in part on a partial overlap between the first SL BWP and the second SL BWP; or transmitting, to the second UE based at least in part on the partial overlap between the first SL BWP and the second SL BWP, an indication associated with adjusting the second SL BWP.

Aspect 2: The method of Aspect 1, wherein the first SL BWP is associated with a first service and the second SL BWP is associated with a second service different than the first service.

Aspect 3: The method of any of Aspects 1-2, wherein adjusting the first SL BWP based at least in part on the partial overlap between the first SL BWP and the second SL BWP comprises switching to a resource pool that is not associated with the partial overlap.

Aspect 4: The method of any of Aspects 1-3, wherein the indication is provided via a UE assistance information message, a radio resource control message, or medium access control signaling via a PC5 interface.

Aspect 5: The method of any of Aspects 1-4, further comprising receiving a response associated with the indication, wherein the response indicates that the second SL BWP was adjusted.

Aspect 6: The method of any of Aspects 1-5, further comprising receiving a response associated with the indication, wherein the response indicates that the second UE switched to a resource pool that is not associated with the partial overlap.

Aspect 7: The method of any of Aspects 1-6, further comprising receiving a response associated with the indication, wherein the response indicates that the second UE adjusted a location of sidelink control information to be included in the partial overlap.

Aspect 8: The method of any of Aspects 1-7, wherein the first SL BWP and the second SL BWP are associated with a same service.

Aspect 9: The method of any of Aspects 1-8, wherein adjusting the first SL BWP based at least in part on the partial overlap between the first SL BWP and the second SL BWP further comprises adjusting the first SL BWP or a resource pool associated with the first SL BWP to align the first SL BWP with the second SL BWP.

Aspect 10: The method of Aspect 9, further comprising: establishing a unicast session with the second UE after adjusting the first SL BWP.

Aspect 11: The method of Aspect 9, further comprising: joining a broadcast or a groupcast session associated with one or more UEs including the second UE.

Aspect 12: A method of wireless communication performed by a network node, comprising: identifying a first sidelink (SL) bandwidth part (BWP) of a first user equipment (UE) and a second SL BWP of a second UE; and transmitting, to the first UE based at least in part on a partial overlap between the first SL BWP and the second SL BWP, an indication associated with adjusting the first SL BWP.

Aspect 13: The method of Aspect 12, wherein the first SL BWP and the second SL BWP are associated with different services.

Aspect 14: The method of any of Aspects 12-13, wherein the first SL BWP and the second SL BWP are associated with a same service.

Aspect 15: The method of any of Aspects 12-14, wherein the indication is provided via a UE assistance information message, a radio resource control message, or a medium access control message.

Aspect 16: The method of any of Aspects 12-15, further comprising receiving a response associated with the indication, wherein the response indicates that the first SL BWP was adjusted.

Aspect 17: The method of any of Aspects 12-16, further comprising receiving a response associated with the indication, wherein the response indicates that the first UE switched to a resource pool that is not associated with the partial overlap.

Aspect 18: The method of any of Aspects 12-17, further comprising receiving a response associated with the indication, wherein the response indicates that the first UE adjusted a location of sidelink control information to be included in the partial overlap.

Aspect 19: The method of any of Aspects 12-18, further comprising receiving a response associated with the indication, wherein the response indicates that the first UE adjusted the first SL BWP or a resource pool associated with the first SL BWP to align the first SL BWP with the second SL BWP.

Aspect 20: An apparatus for wireless communication at a device, comprising a processor; memory coupled with the processor; and instructions stored in the memory and executable by the processor to cause the apparatus to perform the method of one or more of Aspects 1-19.

Aspect 21: A device for wireless communication, comprising a memory and one or more processors coupled to the memory, the one or more processors configured to perform the method of one or more of Aspects 1-19.

Aspect 22: An apparatus for wireless communication, comprising at least one means for performing the method of one or more of Aspects 1-19.

Aspect 23: A non-transitory computer-readable medium storing code for wireless communication, the code comprising instructions executable by a processor to perform the method of one or more of Aspects 1-19.

Aspect 24: A non-transitory computer-readable medium storing a set of instructions for wireless communication, the set of instructions comprising one or more instructions that, when executed by one or more processors of a device, cause the device to perform the method of one or more of Aspects 1-19.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a first user equipment (UE), comprising:
a memory; and
one or more processors, coupled to the memory, configured to:
identify a first sidelink (SL) bandwidth part (BWP) of the first UE and a second SL BWP of a second UE; and
one of:
make an adjustment associated with the first SL BWP based at least in part on a partial overlap between the first SL BWP and the second SL BWP; or
transmit, to the second UE based at least in part on the partial overlap between the first SL BWP and the second SL BWP, an indication associated with adjusting the second SL BWP.

2. The apparatus of claim 1, wherein the first SL BWP is associated with a first service and the second SL BWP is associated with a second service different than the first service.

3. The apparatus of claim 1, wherein the one or more processors, to make the adjustment associated with the first SL BWP based at least in part on the partial overlap between the first SL BWP and the second SL BWP, are configured to switch to a resource pool that is not associated with the partial overlap in frequency.

4. The apparatus of claim 1, wherein the indication is provided via a UE assistance information message, a radio resource control message, or medium access control signaling via a PC5 interface.

5. The apparatus of claim 1, wherein the one or more processors are further configured to receive a response associated with the indication, wherein the response indicates that the second SL BWP was adjusted.

6. The apparatus of claim 1, wherein the one or more processors are further configured to receive a response associated with the indication, wherein the response indicates that the second UE switched to a resource pool that is not associated with the partial overlap.

7. The apparatus of claim 1, wherein the one or more processors are further configured to receive a response associated with the indication, wherein the response indicates that the second UE adjusted a location of sidelink control information to be included in the partial overlap.

8. The apparatus of claim 1, wherein the first SL BWP and the second SL BWP are associated with a same service.

9. The apparatus of claim 1, wherein the one or more processors, to make the adjustment associated with the first SL BWP based at least in part on the partial overlap between the first SL BWP and the second SL BWP, are configured to adjust the first SL BWP or a resource pool associated with the first SL BWP to align the first SL BWP with the second SL BWP.

10. The apparatus of claim 9, wherein the one or more processors are further configured to:
establish a unicast session with the second UE after adjusting the first SL BWP.

11. The apparatus of claim 9, wherein the one or more processors are further configured to:
join a broadcast or a groupcast session associated with one or more UEs including the second UE.

12. An apparatus for wireless communication at a network node, comprising:
a memory; and
one or more processors, coupled to the memory, configured to:
identify a first sidelink (SL) bandwidth part (BWP) of a first user equipment (UE) and a second SL BWP of a second UE; and
transmit, to the first UE based at least in part on a partial overlap between the first SL BWP and the second SL BWP, an indication associated with adjusting the first SL BWP.

13. The apparatus of claim 12, wherein the first SL BWP and the second SL BWP are associated with different services.

14. The apparatus of claim 13, wherein the one or more processors are further configured to receive a response associated with the indication, wherein the response indicates that the first UE adjusted a location of sidelink control information to be included in the partial overlap.

15. The apparatus of claim 12, wherein the first SL BWP and the second SL BWP are associated with a same service.

16. The apparatus of claim 15, wherein the one or more processors are further configured to receive a response associated with the indication, wherein the response indicates that the first UE adjusted the first SL BWP or a resource pool associated with the first SL BWP to align the first SL BWP with the second SL BWP.

17. The apparatus of claim 12, wherein the indication is provided via a UE assistance information message, a radio resource control message, or a medium access control message via a PC5 interface.

18. The apparatus of claim 12, wherein the one or more processors are further configured to receive a response associated with the indication, wherein the response indicates that the first SL BWP was adjusted.

19. The apparatus of claim 12, wherein the one or more processors are further configured to receive a response associated with the indication, wherein the response indicates that the first UE switched to a resource pool that is not associated with the partial overlap.

20. A method of wireless communication performed by a first user equipment (UE), comprising:
identifying a first sidelink (SL) bandwidth part (BWP) of the first UE and a second SL BWP of a second UE; and
one of:
making an adjustment associated with the first SL BWP based at least in part on a partial overlap between the first SL BWP and the second SL BWP; or
transmitting, to the second UE based at least in part on the partial overlap between the first SL BWP and the second SL BWP, an indication associated with adjusting the second SL BWP.

21. The method of claim 20, wherein the first SL BWP is associated with a first service and the second SL BWP is associated with a second service different than the first service.

22. The method of claim 20, wherein making the adjustment associated with the first SL BWP based at least in part on the partial overlap between the first SL BWP and the second SL BWP comprises switching to a resource pool that is not associated with the partial overlap in frequency.

23. The method of claim 20, wherein the indication is provided via a UE assistance information message, a radio resource control message, or medium access control signaling via a PC5 interface.

24. The method of claim 20, further comprising receiving a response associated with the indication, wherein the response indicates that the second SL BWP was adjusted.

25. The method of claim 20, further comprising receiving a response associated with the indication, wherein the response indicates that the second UE switched to a resource pool that is not associated with the partial overlap.

26. The method of claim 20, further comprising receiving a response associated with the indication, wherein the response indicates that the second UE adjusted a location of sidelink control information to be included in the partial overlap.

27. The method of claim 20, wherein the first SL BWP and the second SL BWP are associated with a same service.

28. The method of claim 20, wherein making the adjustment associated with the first SL BWP based at least in part on the partial overlap between the first SL BWP and the second SL BWP further comprises adjusting the first SL BWP or a resource pool associated with the first SL BWP to align the first SL BWP with the second SL BWP.

29. A method of wireless communication performed by a network node, comprising:
identifying a first sidelink (SL) bandwidth part (BWP) of a first user equipment (UE) and a second SL BWP of a second UE; and
transmitting, to the first UE based at least in part on a partial overlap between the first SL BWP and the second SL BWP, an indication associated with adjusting the first SL BWP.

30. The method of claim 29, wherein the first SL BWP and the second SL BWP are associated with different services.
